(19) United States
(12) Patent Application Publication
(10) Pub. No.: US 2015/0108101 A1
(43) Pub. Date: Apr. 23, 2015

(54) METHOD FOR MARKING COMPONENTS OF AN AIRPLANE ENGINE

(71) Applicant: ROFIN-BAASEL LASERTECH GMBH & CO. KG, Starnberg (DE)

(72) Inventors: KARL-HERMANN RICHTER, MARKT INDERSDORF (DE); ROLAND MAYERHOFER, ROETTENBACH (DE); LUDGER MUELLERS, MUENCHEN (DE)

(21) Appl. No.: 14/581,083

(22) Filed: Dec. 23, 2014

Related U.S. Application Data
(63) Continuation of application No. PCT/EP2013/063893, filed on Jul. 2, 2013.

(30) Foreign Application Priority Data
Jul. 10, 2012 (DE) 102012211986.8

(51) Int. Cl. B23K 26/40; B23K 26/06; B23K 26/36

(52) U.S. Cl. CPC B23K 26/402; B23K 26/4015; B23K 26/365; B23K 26/0635
USPC 219/121.61; 219/121.69

(57) ABSTRACT

A method of marking components of an aircraft engine, especially turbine blades of a titanium aluminide intermetallic compound. A solid state laser generates a pulsed laser beam with a pulse width of less than 10 ps and the component is marked with the pulsed laser beam.

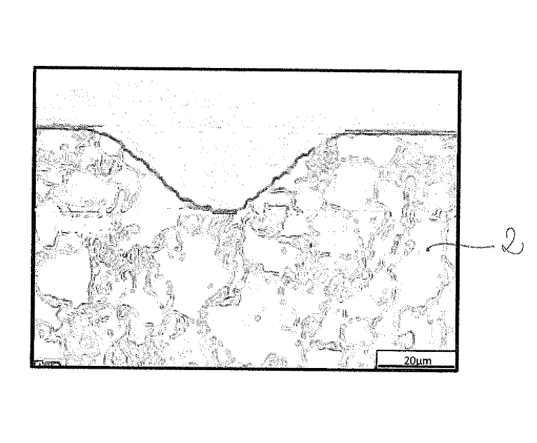

### CROSS-REFERENCE TO RELATED APPLICATION

This application is a continuation, under 35 U.S.C. §120, of our copending international application No. PCT/EP2013/063893, filed Jul. 2, 2013, which designated the United States; this application also claims the priority, under 35 U.S.C. §119, of German patent application No. DE 10 2012 211 986.8, filed Jul. 10, 2012; the prior applications are herewith incorporated by reference in their entirety.

### BACKGROUND OF THE INVENTION

### Field of the Invention

The invention relates to a method for marking components of an aircraft engine.

Aircraft engine components which are relevant for safety and which are subjected to high loading, those referred to as safety class 1 components, are generally marked or labeled with the aid of a laser beam. A marking process carried out using a laser beam is highly reproducible, allows for a short machining time, and can also be automated to a great extent. Pulsed solid-state lasers, whose pulse lengths lie in the nanosecond range, are used as laser beam sources. By machining with such a laser beam, the base material is melted and there results, upon cooling, a re-solidified layer, referred to as the recast layer, which may have cracks which can propagate into the base material. Such cracks are tolerated when labeling turbine blades constructed of nickel-based alloys, as long as limit values, defined in specifications, for the width of this recast layer and the length of the cracks are not exceeded.

Such a recast layer, and cracks in the base material, are however not permissible when labeling turbine blades made of titanium aluminide TiAl, such that turbine blades of this type cannot be labeled using the known laser beam method.

United States published patent application US 2013/0256284 A1 and its counterpart European published patent application EP 2 390 045 A1, for example, describe a method which, for marking an object made of stainless steel, for example, for creating a measurement scale on a strip of stainless steel, uses a laser beam with ultra-short laser pulses with a pulse length of approximately 100 fs.

International patent application publication WO 2007/049064 A1 describes a method for marking surfaces of reflective materials with a laser using pulse lengths in the range from approximately 30 to 160 ns, in order to generate diffusely reflective regions on a non-diffusely reflective surface.

Marking that employs a mechanical stamping method is also not possible. Such a process cannot be used either because intercrystalline crack formation cannot be avoided.

### SUMMARY OF THE INVENTION

It is accordingly an object of the invention to provide a method of marking aircraft engine components, such as turbine blades, which overcomes the disadvantages of the heretofore-known devices of this general type and which provide for the introduction of permanent markings without damaging the base material.

With the above and other objects in view there is provided, in accordance with the invention, a method for marking a component of an aircraft engine, such as a turbine blade made of an intermetallic titanium aluminide compound. The method comprises generating a pulsed laser beam with a solid-state laser having a pulse length less than 10 ps, and marking the component with the pulsed laser beam generated by the solid-state laser.

By using a laser beam generated by such an ultra-short-pulse laser, it is accordingly possible to mark safety class 1 components, in particular turbine blades, for example the low-pressure turbine rotor blades which are made of an intermetallic titanium aluminide compound, in an economical and reproducible manner without causing detectable damage to the base material. The reason for this is the “cold” material removal associated with the extremely short pulse duration, which is caused by the fact that the pulse duration is so short that there is practically no interaction between the conduction electrons, which absorb the laser beams, and the phonons of the lattice.

The method is of particular advantage for use with titanium aluminide materials having the designations TiAl6V4, Ti6242, Ti6246 and Ti834, without this list being exhaustive. It can also be advantageously used with nickel-based materials.

Preferably, for generating the pulsed laser beam, use is made of a so-called femtosecond laser, for example a MOPA solid-state laser or a MOPA fiber laser (Master Oscillator Power Amplifier). These enable generating laser beam pulses whose pulse duration is less than 1 ps.

It is thus possible to largely exclude damage to the base material if the pulse energy is less than 100 μJ, in particular less than 20 μJ, and the mark is introduced in a number of passes.

Typical repetition rates are in the range from 10 to 1000 kHz for scanning speeds between 50 and 1000 mm/s.

Other features which are considered as characteristic for the invention are set forth in the appended claims.

Although the invention is illustrated and described herein as embodied in method for marking components of an aircraft engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE shows a cross section of a laser mark in a component made of an intermetallic titanium aluminide compound, the mark having been made by way of a method according to the invention.

### DETAILED DESCRIPTION OF THE INVENTION

Referring now to the sole FIGURE of the drawing in detail there is shown a groove that has been introduced into a component 2. The component is formed of an intermetallic titanium aluminide compound and the groove has been made by way of a pulsed laser beam generated by a solid-state laser whose pulse length is 0.8 ps=800 fs. In the practical exemplary embodiment, repetition rates of 200 kHz and pulse energies of 15 μJ have proven to be particularly advantageous when using a femtosecond laser of this type at a scanning speed of 500 mm/s.

The mark represented was generated with a material removal of 0.1 μm per pulse. Twenty-five passes proved to be sufficient to finish the mark. When pulse lengths are less than 10 ps, no recast layer is formed, such that no recognizable melt zones arise and therefore a “cold” material removal occurs. This has the advantage that there is no damage to the component or to the base material, since there is practically no interaction between the conduction electrons, which absorb the laser beams, and the phonons of the lattice.

1. A method for marking a component of an aircraft engine, the method comprising: generating a pulsed laser beam with a solid-state laser having a pulse length less than 10 ps, and marking the component with the pulsed laser beam generated by the solid-state laser.

2. The method according to claim 1, marking the component in the form of a turbine blade made of an intermetallic titanium aluminide compound.

3. The method according to claim 1, which comprises setting the pulse length to less than 1 ps.

4. The method according to claim 1, which comprises driving the laser with a pulse energy of less than 100 μJ and marking the component by introducing a mark in a plurality of passes.

5. The method according to claim 4, which comprises setting the pulse energy to less than 20 μJ.
